(19) United States
(12) Patent Application Publication
(10) Pub. No.: US 2006/0138727 A1
(43) Pub. Date: Jun. 29, 2006

(54) Introduction system

(76) Inventor: John Lahiri Khan, London (GB)

Correspondence Address: JOHN LAHIRI KHAN, 31 NORTHUMBERLAND PLACE, LONDON, W2 5AS, GB

(21) Appl. No.: 11/264,917

(22) Filed: Nov. 3, 2005

(30) Foreign Application Priority Data
Dec. 23, 2004 (GB) GB 0428269.5
Jul. 20, 2005 (GB) GB 0514898.6

(51) Int. Cl. A63F 1/00; G08B 23/00; G08B 1/08

(52) U.S. Cl. 273/292; 340/500; 340/539.22

(57) ABSTRACT

An introduction system for making new friends and/or dating without time limits, potentially throughout life, easily, inexpensively and even unexpectedly, in which anyone can try to attract anyone they encounter entirely by chance or otherwise, immediately or subsequently into an introduction process, using a ring and/or other device. The ring/other device has a logo and/or is otherwise distinctive in appearance and/or design and is used as a ‘people magnet’ to effect entry into the introduction process. Flash cards/other devices may be used in this process to help determine compatibility, to help terminate unsuitable introductions very quickly and/or to provide other information, including contact details of a centralized administrative agency that may be established to facilitate introductions and to publicize, develop and market the system and related merchandise.

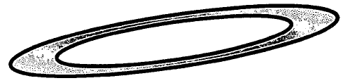

### CROSS-REFERENCE TO RELATED APPLICATIONS

This application claims the foreign priority benefit of U.K. Application number GB0428269.5 filed on 23 Dec. 2004 and U.K. Application number GB0514898.6 filed on 20 Jul. 2005.

### STATEMENT REGARDING FEDERALLY SPONSORED RESEARCH OR DEVELOPMENT

Not Applicable.

### REFERENCE TO SEQUENCE LISTING

Not Applicable.

### BACKGROUND OF THE INVENTION

This invention relates to an innovative introduction system for making friends and/or dating. Finding friends or dates can be a costly, difficult and daunting process. Conventional introduction methods often require considerable motivation to begin the process as well as much effort and financial outlay each time such an attempt is made and are usually aimed at a concentrated targeted market.

The following prior art patent documents are not seen to disclose this present invention: U.S. Pat. No. 6,386,455 B1 issued to Junior George Wynter on May 14, 2002 describes a badge arrangement, intended for use especially at singles gatherings, in which there is a badge with an electrically actuated visual or audio indicator that may be responsive to signals and a remote control to actuate the indicator. Badge wearers may operate their remote controls when facing other badge wearers with whom they wish to arrange dates and those other badge wearers may use their remote controls to respond if they so wish.

U.S. Pat. No. 6,150,937 issued to Michael I. Rackman on Nov. 21, 2000 describes a set of devices such as badges, which may contain personal information, transmitting contact signals. Those devices may blink if two wearers are in proximity to each other.

U.S. Pat. No. 5,920,845 issued to Rafael Risemberg on Jul. 6, 1999 describes a date matching method in which the participants are assigned, and display, unique identification codes at dating events and in which they indicate date preferences on cards that may be analyzed to match the participants.

U.S. Pat. No. 6,086,394 issued to Shmuel Shapira on Feb. 4, 1992 describes an introduction system in which each participating user has a personal device activated by paging and a memory device containing personal data and those users can be matched using computer comparison of their personal data.

The inventions described in these prior art documents require all the participants in the introduction system to possess and use devices as described. However, this present invention requires only individual participants to possess and use a device/devices for the purpose of introduction to anyone they encounter. Those people encountered do not need to have a device, nor do they need to be intent on participating in an introduction.

Moreover, the main device that will be described for this invention, a ring, may easily be left on without having to think about it. Devices such as this, for example other items of jewelry, may continue to operate anywhere, effortlessly for an indefinitely long period of time, even throughout life, and not just when new friends or dates are being sought actively.

### BRIEF SUMMARY OF THE INVENTION

To overcome the problem of finding friends or dates, the present invention proposes a new introduction system, comprising one or more devices for a new introduction process. The introduction system will be referred to as ‘Flash Dating’ throughout this document, but another name may eventually be chosen instead.

Flash Dating will be an innovative system that firstly, is intended to allow people to find new friends and/or date on a continuous, effortless and on-going basis and secondly, may be capable of allowing people to decide very quickly whether or not they might be compatible with each other as well as to terminate unsuitable introductions very quickly.

The former is expected to be carried out largely using a ring that will be distinctive in appearance and/or design (e.g. by using a logo). This ring will be referred to as an ‘Availability Ring’ throughout this document, but another name may eventually be chosen instead. The latter could be facilitated as necessary by, for example, durable, compact flash cards that could be carried around easily if so required. Flash cards providing other information, preferably presented in a concise way, could also form a part of the complete introduction system.

A ring with flash cards is one example of the invention and will be described mainly in this document. However, it would be possible to use, instead of the ring (or with the ring), other devices for use as ‘people magnets’ to indicate availability for introductions of the type described in this document including, for example, other items of jewelry. Any of the ‘people magnets’, including the ring, may be used alone for Flash Dating.

It would be possible to use, instead of the flash cards (or with the flash cards), other devices carrying information for introductions of the type described in this document including, for example, cell phones and other mobile electronic devices. Devices such as the flash cards (and other information-carrying devices) might be capable of being used alone to facilitate introductions generally. However, this would depend on the particular device and/or its content.

It is intended that even devices intended for use with others may be sold separately, rather than necessarily sold together.

An Availability Ring will be able to be worn by anyone as much or as little as required, allowing continuous, effortless and on-going opportunities for anyone wearing it to make friends with new people in almost all situations and locations. The fact that Availability Rings are for the purpose of being used as ‘people magnets’ for entry into an introduction process that is available and open to anyone and in which anyone can try to attract anyone else they encounter anywhere for the purpose of making friends and/or dating, completely distinguishes them from rings (or other devices) worn, for example, that show belonging to a specialist group within society.

This is applicable to other ‘people magnets’ too. Availability Rings and other ‘people magnets’ may even be presented and marketed as a type of fashion accessory and using them, as a new and everlasting way of making people more ‘attractive’ (or at the very least, more approachable) to other people, as well as helping make loneliness a thing of the past.

Flash cards, if used, could help make the immediate follow-up to the initial contact as quick, easy, effective, automatic and stress-free as possible. Most importantly, the cards could enable the possible compatibility of people to be decided unusually quickly; only an exceptionally short time may be available when Flash Dating. Many, if not all the points on the cards might seem obvious to someone experienced in making conversation or dating. However the emphasis here is on speed and the cards could also provide a good reason or excuse to terminate the introduction at any point immediately if so desired. In fact, the use of the flash cards in such circumstances and in such a way, especially if they are physically present and visible, would probably be considered unacceptable in other forms of dating. The essential points on the cards should become easy to remember, making their physical presence entirely optional or unnecessary when Flash Dating.

The invention should provide an effortless and inexpensive, yet hopefully effective and long-lasting way of making new friends or dates. This could be possible for very many years even, perhaps, throughout life and all this for just the initial cost of buying a device such as a ring or a combination of devices such as a ring and flash cards. This invention is unlike present introduction methods which often involve much time, expense and effort including, for example, having to think of how to look, what to say and, usually, where and when to meet to make good first impressions. Present introduction methods also often result in the efforts having to be made in concentrated spurts, with accompanying pressure, rather than continuously over time.

In addition, present introduction agency methods suffer from the fact that some things are only found when one is not looking for them. They also often involve spending a much longer time on individuals whom one would quickly realize are unsuitable.

In these ways, the invention makes a contribution to introduction methods. It is hoped that it will eventually make an important contribution to the lives and happiness of very many people worldwide.

### BRIEF DESCRIPTION OF THE DRAWING

The drawing is just one example of the many possible types of logo that may be used to indicate availability for Flash Dating, but is unlikely to be the final design. The drawing is intended to be a logo possibly representing a ‘wide circle’ of friends.

### DETAILED DESCRIPTION OF THE INVENTION

Flash Dating will comprise one or more devices for a new introduction process. An example of such a device is an Availability Ring. An Availability Ring used with a set of flash cards will be described within this section as an illustrative example of the invention.

The Flash Dating introduction process may involve such stages as: ‘people magnets’ being used, ‘people magnets’ being noticed, entry into introductions occurring, introductions continuing and introductions ending.

Flash Dating could possibly use other items that may or may not be specifically for Flash Dating. It is intended that devices for use in Flash Dating may be purchased, but devices could be presented and sold either separately or together. It is also intended that there may be contact details (such as website address/email address/telephone number/fax number/text, video or other messaging number) of such processing means as a centralized administrative agency that may be set up and given a name such as ‘Flash Dating Agency’.

The design of the Availability Ring (and other devices to show availability for Flash Dating) is expected to be protected as a registered design to increase the market potential of the invention. For the same reason, the logo expected to be used on devices for Flash Dating would also be expected to be registered as a trademark. The drawing illustrates a type of logo that could be used but is unlikely to be the one adopted, which may well be more intricate and distinctive, as well as harder to copy. A logo chosen may involve a picture. It may involve wording. It will almost certainly involve color. It is hoped that any logo adopted will become used and recognized universally for Flash Dating.

However, there is little reason apart from market potential as to why a very simple sign, such as just a circle, triangle, star or even a color, could not be used. These could make the logo or sign already widely available and easy to reproduce. If logos or signs such as these were adopted, this should only perhaps be at a very much later stage, possibly in a junior friendship fun-type or economy version with logo stickers that could be shared, or else considered for trial in another country. The invention might then perhaps appear as, for example, ‘Circle Dating’ or ‘Star Dating’.

The profitability of the invention could however be expected to be greatly diminished using a very simple logo or sign since there would be less need to purchase the devices. Nevertheless this could well increase the potential of the invention to benefit society over time, especially if a centralized administrative Flash Dating Agency remained economically viable for its promotion, development and back up. This could eventually lead to the widespread adoption of a very simple logo or sign giving limitless new opportunities for making friends and dating throughout society at little or no cost whatsoever.

Any logo used on an Availability Ring would be expected to be distinctive and could be used on other merchandise that could either be available for individual purchase or else included as part of a package/combination, though most of it probably only at a later stage, from the centralized Flash Dating Agency. Examples of such merchandise include jewelry (including rings); love charms, leaflets, bags and T-shirts. Some items such as stickers, badges, bands, etc., could make the logo much too accessible if they were made available, because they could easily be given away free to other people, greatly reducing sales of the other devices, but this may still be considered beneficial, especially in the future.

An Availability Ring will be worn by anyone who wishes to say that the ring wearer is happy, or at least immediately available, to talk to anyone who sees it and in particular, someone not already known to the wearer. In this way, an initial opportunity for conversation with new people is provided.

It may be considered desirable to be able to distinguish visibly between the ways an Availability Ring (and/or other devices) are being used e.g. whether solely for dating or simply for making new friends. This may be done according to the position of some devices in use. For example, for a ring, it could be done by wearing the ring on different hands (or different fingers) depending on its use. For a ring and other devices, it could also be done by using separate designs/different appearances (e.g. by using different colors on the logo and/or on all or part of the device itself).

If the opportunity for conversation is taken up, the conversation can then, although this is not essential, begin by going through a few points on the starter flash card that require only very short answers concerning the status of the person introducing themselves and for what they are searching (the wearer will start asking questions and making comments using the card or from memory of the card). At this stage, later on, or even before any conversation gets under way at all, the wearer can say that the introducer does not meet the wearer's search criteria (without any need to clarify which) and the conversation can and should be ended immediately. Some examples of status and search preference points are: whether the introducer and wearer are looking for friends or dates, if dates, whether short-term or long-term, whether they are single or in a relationship, their ages (within a broad range), whether they have children or not and whether or not they are smokers.

The starter flash card and/or one or more follow-up flash cards could contain many further points of conversation, some of which may require lengthier answers including, for example, what sort of job they have, in which area they live, hobbies, pets and type of car, if they drive.

Points of conversation that are very much more general such as personal descriptions including, for example, personal qualities, strengths and weaknesses may be included towards the end of a follow-up flash card and could be discussed, if so desired, at length at any subsequent meeting if arranged.

The starter flash card/follow-up flash cards could be arranged progressively to help determine compatibility as quickly as possible. For example, the earliest points of conversation could be those points capable of being dealt with speedily that are of most importance in determining compatibility. Later points could be less important in determining compatibility and/or take a longer time to deal with.

There could also be a flash card, perhaps personalized with, for example, at least one personal registration number/code or similar for optional use printed on it, also perhaps giving the centralized administrative Flash Dating Agency's contact details. The ‘people magnets’, including Availability Rings', could be personalized more directly by having those numbers and/or codes or similar on them. Such numbers/codes may be used to facilitate communication with the Flash Dating Agency as well as between participants in Flash Dating. These may be particularly useful for users who would not want to give out personal information such as their telephone numbers to a complete stranger and may prefer to make future contact through the Flash Dating Agency.

Contact details of the Flash Dating Agency that could be given include a website address/email address/telephone number/fax number/messaging number, as mentioned previously, some or all of which could be used, amongst other things, to check out, if so desired, times, dates and locations of flash mob introduction venues and/or other venues where people may gather, possibly in large numbers. These could involve ring wearers meeting at pre-determined venues, including public places, and the gatherings could be advertised by emailing and text messaging, for example, and even possibly publicized by the mass media. Such introductions, some of which may be specifically for making friends (including those of the same sex and/or opposite sex) and some specifically for dating, could be arranged by the Flash Dating Agency as well as by individuals, possibly through the Flash Dating Agency.

The Flash Dating Agency's contact details could also be used by individuals, if required, to place, as well as reply to advertisements for dates (or friends) in a traditional way but perhaps at a low cost to Availability Ring holders. The Flash Dating Agency could also be able to publicize, develop and market the Flash Dating system and related merchandise.

Other flash cards could contain back-up and peripheral information, preferably presented in a concise way e.g. instructions for Flash Dating, precautions when first meeting strangers, self-defense tips, do's and don'ts of dating/making friends/keeping friends, fin-type/other interesting information (such as star sign descriptions), body language tips, kissing tips and optional explicit questions.

There could be optional blank cards for giving out at least one contact detail (e.g. telephone number or personal registration number) for use by the ring wearer and introducer, possibly with contact details of the Flash Dating Agency, as well, providing it with additional publicity. It might be possible for the introducer to leave a message through the Flash Dating Agency if, for example, just the wearer's name or another name and/or suitable word/password or a personal registration number/code or similar was given and for users' messages to be received/stored/processed/transmitted electronically e.g. by such means as computer. Computers, cell or mobile phones and/or other mobile electronic devices, for example, could be used to carry such information.

Different types of flash cards may, for example, be color-coded (such as according to their function), to allow particular cards to be found more easily. This would be one of the possible ways in which such information-carrying devices could be made more convenient to use. Some devices, including flash cards and booklets, may use such means as an index or similar.

The flash cards may be capable of being used alone to facilitate other types of introduction, depending on their particular functions. For example, the flash cards (and other information-carrying devices e.g. booklets and electronic devices displaying information) may be of use generally in helping determine compatibility and in terminating unsuitable introductions.

There could also be, though possibly at a later stage of development, information on buying other merchandise from the Flash Dating Agency. Most prominent and possibly amongst the earliest obtainable of these could be other, high quality, very attractive Availability Rings that may be ordered exclusively from the Flash Dating Agency in different ring sizes.

The initial Availability Ring, that may be available either individually or as part of a package/combination, could be basic, but preferably also attractive-looking and possibly a signet or medallion ring. It could also be either a universal fit ring e.g. a clip-on type or else a ring available in different sizes. In common with other Availability Rings and probably most other merchandise from the Flash Dating Agency, it is expected that it would display a Flash Dating logo.

Although Availability Rings would not be intended to be very conspicuous, they would be noticeable (so helping to advertise the invention incidentally by word of mouth) and would allow easy recognition by anyone who knew about Flash Dating. Flash Dating would be expected to be widely publicized by the Flash Dating Agency from the very start, including during the process of marketing the devices.

A ring would be expected to be the best form of ‘people magnet’ for use in the introduction process, especially because it can be left on for an indefinitely long time without thinking about it. A ring may also be put on or taken off easily.

Optional design features could help to make rings and other ‘people magnets’ more noticeable, if so desired e.g. light-emitting and/or sound-emitting capabilities. Conceivably, these could also include various light-emitting options, such as lighting of one or more colors, flashing lighting and/or electronic displays. Lighting/electronic displays (which may show a logo) of different colors may also, for example, be used to distinguish between different purposes for which such a device is used e.g. whether for dating or simply for making new friends. Sound-emitting options could include means to change or to adjust/regulate the sound, especially its volume.

Other optional design features could allow the appearance of some ‘people magnets’, including rings, to show that they are being used as ‘people magnets’ only when this is required. For example, some ‘people magnets’ may include a logo or similar that is capable of being concealed and/or moved if necessary (e.g. by reversal of the part displaying a logo). Some may be able to use lighting parts, including electronic displays (which may show a logo), which could be turned off in order to show that a ‘people magnet’ is not in use.

There would be occasions when ‘people magnets’ other than rings, such as those that would be more noticeable, might be used and other packages/combinations could also be used for the purpose of Flash Dating. Just a few of the many possible examples are: a band (such as a wrist band) with flash cards, a badge with flash cards, logo stickers with flash cards, a T-shirt with a booklet’, a ring with a booklet and a ring with a cell phone.

In fact there could be versions of Flash Dating that might include or consist of one (or more) items of the following class that will be referred to as ‘Group A’ with, or without, one (or more) items of the following class that will be referred to as ‘Group B’ (and possibly other items as well). It is intended that even items from Group A that are intended for use in combination or association with items from Group B may be sold separately, rather than necessarily sold together. So too could items from Group B be sold separately from items in Group A. Items from Group A may be used individually for Flash Dating. Items from Group B may be capable of being used individually to facilitate introductions generally, depending on the items and/or their content. The Groups A and B contain lists of examples and not every possible item is specified in each class. Neither is the scope of the present invention to be considered as limited by the embodiments that are given as examples within this document.

It may be possible to combine physically some items from Groups A and B into what is, or may effectively be, a single device suitable for Flash Dating. An example would be a shoulder bag, perhaps displaying a Flash Dating logo on just one side (so that the logo could be displayed optionally), with a side pocket containing flash cards for Flash Dating.

Items belonging to the class referred to as ‘Group A’ would need to be distinctive enough in appearance and/or design to show that they are for use as ‘people magnets’ to indicate availability for introductions of the type described in this document. This could be achieved, for example, by using a logo or other sign or trademark and/or by having a distinctive appearance and/or design for the whole or part of the item. Any number of features might be used to help make individual items (and/or their logo, sign, trademark or decorative features) distinctive enough in appearance and/or design. These could include colors, shapes, lines, contours, sizes, dimensions and constituents, including component parts and materials used. A bright and distinctive/unusual color or color combination might be particularly noticeable and useful.

Items belonging to the class referred to as ‘Group B’ would need to be able to carry information for introductions of the type described in this document. Any item capable of carrying such information could be considered suitable even though some would be more convenient to use than others.

Although an entirely new and original logo (or sign or other distinguishing feature) may well be used (and is expected to be used) for Flash Dating, it is not intended to preclude the possible use of any logo (or sign or distinguishing feature), including that of another company, for example a sponsor company, possibly allowing synergic advertising/marketing opportunities. However, if such a logo were used on items from Group A, the items might then perhaps still need to be made more distinctive using one or more other means such as those mentioned above e.g. by the way that color is used on all or part of items, which could include the logo itself, to confirm with certainty that the items are being used as ‘people magnets’ to indicate availability for Flash Dating (which could possibly even be in addition to a use such as advertising/marketing).

Group A

Devices Capable of Showing Availability for Flash Dating/Potential ‘People Magnets’

Rings/Bands/Badges/Brooches

Stickers/Labels/Tags/Transfers/Clip-on items/Attachments/Buttons/Emblems

T-shirts/Hats/Headgear/Shoes/Footwear/Ties/Scarves/Gloves

Other clothing (e.g. coats, jackets, shirts, jumpers, blouses, trousers, jeans, skirts, dresses, suits)

Bags (e.g. shoulder bags/handbags, knapsacks/rucksacks, carrier bags)

Other jewelry (e.g. necklaces, bracelets, anklets, bangles, earrings, chains, pendants, lockets, charms, cufflinks, body jewelry)

Other items that are worn (e.g. belts, hair accessories, glasses, watches)

Other items that are held or carried (e.g. umbrellas, key rings, personal music devices)

Other items that are attached to, applied to, accompany or are noticeable with the body

Translucent/Fluorescent/Luminous/Phosphorescent Items, including any of the above

Items, including any of the above, with light-emitting capabilities/electronic displays

Items, including any of the above, with sound-emitting capabilities

Items above that can also carry information for Flash Dating

Group B

Devices Capable of Carrying Information for the Purpose of Flash Dating

Sets of cards/Packs of cards/Flash cards/Cards

Individual cards/Individual flash cards

Booklets/Books/Brochures/Pamphlets/Pads

Leaflets/Packaging items (e.g. wrappers, containers)/Labels/Tags/Attachments

Electronic versions of cards/Electronic versions of packs of cards

Products of information technology/Computers

Cell phones/Mobile phones/Mobile electronic devices/Products of mobile phone technology

Other items that can carry information around

Electronic/Electrical/Other items that can store information (e.g. disks, tapes, smart cards)

Electronic/Electrical/Other items that can display information

Electronic/Electrical/Other items that can carry information

Items carrying any of the above (e.g. wallets, bags, cases)

Items above that can also show availability for Flash Dating

I claim:

1. An introduction system for making friends and/or dating, comprising a ring (and/or other device) for an introduction process in which anyone can try, over any time period, to attract into an introduction anyone they encounter either entirely by chance or otherwise, immediately or subsequently, by using that ring (and/or other device) that has a logo and/or is otherwise distinctive in appearance and/or design and that is, by being noticed, capable of being identified by people encountered as being for the purpose of effecting introductions in this way.

2. An introduction system, according to claim 1, that additionally comprises a set of cards (and/or other device) for use visibly or otherwise, to help determine immediately or subsequently the compatibility of participants in that introduction system and/or to provide a reason and/or excuse to terminate an unsuitable introduction immediately or subsequently and/or in providing other information.

3. An introduction system, according to claim 1, wherein the ring (and/or other device) is associated with one or more unique identifiers, comprising one or more personal numbers and/or codes and/or other unique identifiers, to facilitate communications between participants in that introduction system and a processing means remote from participants in that introduction system and/or to facilitate communications between participants in that introduction system and other participants in that introduction system.

4. An introduction system, according to claim 1, wherein the particular purpose of the ring (and/or other device), whether for making friends or for dating or for any other particular purpose, is capable of being identified by people encountered according to the position of that ring (and/or other device) in use and/or the appearance/design of that ring (and/or other device).

5. An introduction system, according to claim 1, wherein the logo or sign or other distinguishing feature of the ring (and/or other device) has previously been used for, and/or is additionally used for, a purpose other than that of effecting entry into that introduction process.

6. An introduction system, according to claim 1, wherein a bangle or a bracelet or a pendant or a necklace or earrings or another item of jewelry is used instead of said ring.

7. An introduction system, according to claim 1, wherein a badge or a band or a bag or stickers or headgear or a T-shirt or another item of clothing is used instead of said ring.

8. An introduction system, according to claim 1, wherein any of the items of the class referred to as ‘Group A’, namely any device capable of showing availability for the introductions, is used instead of said ring.

9. An introduction system, according to claim 1, that also has communication means remote from participants in that introduction system to facilitate the introductions, comprising one or more computers and/or fax machines and/or telephones and/or other devices, that enable communication between participants in that introduction system and a processing means remote from participants in that introduction system.

10. An introduction system, according to claim 1, that additionally comprises a processing means remote from participants in that introduction system having one or more devices to receive information and/or to store information and/or to process information and/or to transmit information.

11. An introduction system, according to claim 1, wherein the ring (and/or other device) has light-emitting means and/or sound-emitting means and/or lighting of one or more colors and/or flashing lighting and/or electronic displays and/or means to change/adjust/regulate sound emission.

12. An introduction system, according to claim 1, wherein the ring (and/or other device) has modification means for modifying the appearance of the device comprising lighting parts/electronic displays with a plurality of colored light options and/or lighting parts/electronic displays that can be turned on and off and/or any part or parts of the device displaying a logo or sign or other distinguishing feature that can be concealed and/or moved.

13. An introduction system, according to claim 2, wherein the ring (and/or other device) is packaged with or combined with or associated with or is separate from the set of cards (and/or other device).

14. An introduction system, according to claim 2, wherein a pack of cards or flash cards or a booklet or a leaflet or a card or cards or an electronic version of a card or an electronic version of cards or a cell phone or a mobile phone or an electronic mobile device or an electronic device that has a display for displaying the information or an electronic device that has another means for accessing the information is used instead of said set of cards.

15. An introduction system, according to claim 2, wherein any of the items of the class referred to as ‘Group A’, namely any device capable of showing availability for the introductions, is used instead of said ring and/or wherein any of the items of the class referred to as ‘Group B’, namely any device capable of carrying information for the introductions, is used instead of said set of cards.

16. An introduction system, according to claim 2, wherein the ring (and/or other device) and/or the set of cards (and/or other device) is associated with one or more unique identifiers, comprising one or more personal numbers and/or codes and/or other unique identifiers, to facilitate communications between participants in that introduction system and a processing means remote from participants in that introduction system and/or to facilitate communications between participants in that introduction system and other participants in that introduction system.

17. A set of cards (and/or other device), comprising a plurality of parts that are arranged progressively according to their speed in determining the compatibility of participants in an introduction and/or their importance in determining the compatibility of participants in an introduction, for use visibly or otherwise, to help determine immediately or subsequently the compatibility of participants in an introduction and/or to provide a reason and/or excuse to terminate an unsuitable introduction immediately or subsequently.

18. A set of cards (and/or other device), according to claim 17, comprising a plurality of parts, of which each part is associated with a color (and/or an index and/or another means is used) to facilitate the finding of a particular part.
